(19) United States
(12) Patent Application Publication
(10) Pub. No.: US 2006/0059110 A1
(43) Pub. Date: Mar. 16, 2006

(54) System and method for detecting card fraud

(76) Inventors: Ajay Madhok, New Delhi (IN); Chitra Madhok, New Delhi (IN); Pankaj Sethi, New Delhi (IN)

Correspondence Address: PEDERSEN & COMPANY, PLLC, P.O. BOX 2666, BOISE, ID, 83701, US

(21) Appl. No.: 10/510,277

(22) PCT Filed: Apr. 3, 2002
(86) PCT No.: PCT/IN02/00100

§ 371 Date: Aug. 15, 2005

(51) Int. Cl. G06Q 99/00

(52) U.S. Cl. 705/75

(57) ABSTRACT

The invention discloses a system and method for notifying and authorizing card transaction by a user. The notifying and authorizing a card is done by a card fraud control system. The card user is notified on his hand held device by a short message service that a card transaction is taking place. The card user can also authorize the credit card transaction by keying in a personal identification number from his hand held device. The system also enables the user to change the rule-based system for a credit card transaction using voice and text inputs from a hand held device.

### BACKGROUND

1. Field of the Invention

The invention relates to detection of fraud and control management in banking transactions. More particularly the invention relates to notifying and authorizing credit card transactions in accordance with personalized rules set up by a credit card holder of a bank.

2. Description of the Related Art

Modern day banking requires several ways of transferring money from one account to another. There are number of banking instruments and modes of transferring money from one account to another. Some of the modes of transfer of money and banking instruments are cheques, credit cards, smart cards, online transfers, etc. The biggest issue and challenge that the Banks face today is that of the security for its customers.

With each mode of transfer of money, banks are providing unique security features to make the transactions fraud proof. Various banking instruments along with their security check systems are described hereunder:

Typically, the transfer of money from one account to another takes place by way of cheques-signed by the drawer in favour of drawee. The customer of the Bank signs a negotiable instrument (generally a cheque issued by the bank) and upon presentation of this cheque to the Bank, the Bank physically verifies the signature of its customers and then releases the amount to the drawee. Though this procedure of transfer of money is simple and effective, it is also time-consuming and involves a chance of human error.

Today, credit cards are increasingly becoming the most popular way of purchasing goods. When a buyer presents the credit card to the retail outlet, the seller verifies the payment process by calling the bank on telephone. The bank then certifies that the goods can be purchased and that the bank will make the payment to the seller. However, if the credit card holder has defaulted on his earlier payments to the bank or the credit card limit has exceeded, the bank refuse the payment to the seller and the credit card holder cannot buy the goods.

Another way in which a seller can verify credit card transactions is through Electronic Data Capture (EDC) magstripe-card swipe terminals. The stripe on the back of a credit card is a magnetic stripe, often called a magstripe. The magstripe is made up of tiny iron-based magnetic particles in a plastic-like film. The magstripe contains various information required for transaction—encrypted personal identification number PIN, country code, amount authorized, currency to be transacted etc. It is very similar to magnetic tape. The magistripe reader can understand the information on magistripe.

After the seller swipes the credit card through an EDC, the EDC software at the point-of-sale terminal dials a stored telephone number via a modem to call an acquirer. An acquirer is an organization that collects credit-authentication requests from sellers and provides the sellers with a payment guarantee. When the acquirer company gets the credit-card authentication request, it checks the transaction for validity and the record on the magstripe for—seller ID, valid card number, expiration date, credit-card limit and card usage, etc. In this manner the EDC magstripe-card terminal does the process of verification of the credit card in a few seconds.

Another mode of transfer of money is online purchase of goods using credit cards. The exponential growth of Internet has transformed the way business is being conducted. With only a computer, browser and the Internet, millions of world wide consumers can go shopping at any time and any place to purchase products from airplanes to needles. The Internet is radically changing the way buyers' shop for goods and services. Buyers are more than willing to satisfy their appetite to buy whatever they need, whenever they need, without leaving the comfort of their office or home. In online banking transactions, customer can make purchases on the Internet by entering the credit card number and other details as required by the validation authority. Sometimes, the Banks also issue another password (called T-PIN or H-PIN) in order to validate the online transactions. The information entered online, go to the central server maintained by the Bank/validation authority, where the security checks and validations are done. Upon checking all the details, the Bank validates the transaction and authorizes the purchase of the goods.

Banks also issue smart cards to its customers. Smart card is a plastic card usually with similar dimensions to a standard credit card. Instead of a magnetic stripe, smart card uses an embedded computer chip and memory to store and process information. Depending on the particular smart card product, smart cards can hold at least 100 or more times as much data as a magstripe card. For example the latest American Express smart blue cards contain 32 k of rewrite-able memory. Smart cards allow information to be stored on the card rather than on a computer. This is an added advantage for security and allows encryption techniques to be used on the card. One benefit of modern smart cards is their ability to replace common functions of several magnetic stripe cards on a single smart card. For example, a single smart card could potentially contain one or more credit cards, an electronic purse, an electronic signature, social security benefits card, a library card, and so on. Since smart card has more information about the cardholder on the card, there will be several validations before a transaction can take place. Smartcards are more durable than traditional magnetic stripe cards as the chip cannot be affected by magnetic fields or there cannot be any scratches like that on the existing magnetic stripe.

All the above-mentioned banking instruments do provide for certain level of security to the customer. However, frauds in transferring money can occur in any banking instruments. This can also happen when a banking instrument is misplaced or lost and the customer does not immediately inform the bank about the same. Banking frauds can also occur when counterfeit instruments (such as cheques, credit card, etc) are being used.

None of the method or system for transfer of money as described above provides for personalized control and management to a customer of the bank. To overcome these problems various fraud detection systems have been discussed in the prior art.

U.S. Pat. No. 6,270,011 titled “Remote credit card authentication system” assigned to Benenson Tal & Mimoun Elie is a method for providing secure transactions with credit cards. The patent discloses a way in which fingerprint data is obtained at the point-of-sale. Credit card company database can verify the fingerprint data against stored fingerprint information and verify the transaction accordingly. The method is integrated into the existing negotiation protocol between a point-of-sale system and a credit card company database, and uses a human fingerprint and a secure algorithm. In the case of an Internet purchase, the inventive method incorporates an authorization adaptor connected to the user PC. Once the user has made the purchase request, an encrypted communication is then commenced in which a token is sent by the credit card Company to the user PC, requesting fingerprint data. The authorization adaptor provides the fingerprint scan, and sends the data to the user PC in encrypted form, for transfer to the credit card company by a secure communication, for authorization. However this system is very time consuming, as the fingerprint has to be scanned and then compared with a stored fingerprint in the database. Also additional hardware has to be bought to implement this system. Hence this system does not provide a complete solution to detect early frauds in credit card usage.

U.S. Pat. No. 5,513,250 titled “Telephone based credit card protection” assigned to Bell Atlantic Network Services, Inc is a system and method for enhancing the security of use of a transaction device such as a credit card through a telephone system. In accordance with this invention, the subscriber has to establish through the telephone network a series of parameters that must be satisfied in order to activate the credit card to permit validation of the card through the conventional point-of-sale magnetic swiping device.

The parameters may include an activation area, a dollar limit on purchasing power, a temporary PIN valid subject to satisfaction of the other parameters, and/or even voice verification. However the system and method has drawback that it requires a separate telephone network for verification. Moreover, it is always the credit card holder who has to initiate the call. Hence this system does not provide a complete solution to detect early frauds in credit card usage.

U.S. Pat. No. 6,012,144, titled as “Transaction Security method and Apparatus”, describes a method for performing secure transaction networks, such as credit card purchases, using two or more non-secure networks (such as the Internet and the public telephone system) in such a way that the security is insured. In this invention, credit card holder initiates the transaction by inputting a part of the credit card number over the non-secure network (say Internet) to the remote computer. The remote computer system thereafter communicates with the credit card holder through an Interactive Voice Response (IVR) System to prompt the user to input the remaining part of the credit card number. After getting the complete information on the credit card, the computer system sends a message to the selected credit card company over the secured network to complete the transaction. This invention uses two networks to confirm the transaction from the cardholder and thus minimize the effect of leakage of information over the non-secure networks. However, this invention cannot be used when unauthorized person is misusing the credit card over the non-secure networks. Moreover, the invention is mainly used for the transactions made over the Internet and confirmed from the cardholder using a telephone network. Therefore, the cardholder has to be physically near the ‘two non secure networks’ in order to complete the transaction. This can make the completion of the transaction a difficult and cumbersome for the cardholder. Hence this system also does not provide a complete solution to detect early frauds in credit card usage.

U.S. Pat. No 6,095,413 titled “System and method for enhanced fraud detection in automated electronic credit card processing” assigned to Automated Transaction Corporation Inc. In this invention, a user at a remote terminal attempting to conduct an electronic credit card transaction is prompted to input the user's credit card information, address, and social security number. The information input by the user is retrieved by a database having a stored list of social security numbers, addresses and user's credit card information. If the credit card information is confirmed to be valid, the electronic credit card transaction is authorized and allowed to transpire. However this system and method has a drawback that if any person knows the social security number he could misuse the lost/stolen credit card. Hence this system does not provide a complete solution to detect early frauds in credit card usage.

Apart from the above-mentioned granted patents, various other products also exist in the market, which authenticate the credit card transactions. These systems use various mobile technologies as well as other technologies to verify the credit card transaction.

On such product refers to a European payment processing giant Europay working with Finnish mobile phone specialist Sonera Smart Trust. The system can be used by anyone with a mobile phone and works by sending an SMS text message to the phone of the person ordering goods and services via any mode such as TV, landline, mobile phone or the Internet. The text message summarizes the transaction and asks the owner of the phone to confirm it using their PIN number. The reply to this message contains not only the PIN but also a digital signature that has been embedded in the phone's SIM card. The digital signature gives proof that you are involved in the transaction.

Another product, the Mobile 3-D Secure, is developed in conjunction with some 15 major industry players, including Aether Systems, Arcot Systems, Brodia, Brokat, KeyCorp, Ericsson, Gemplus, Gpayments, MobileWay, Motorola, Oracle Mobile, Orbiscom, Skygo, SmartTrust, Toshiba and Trintech.

Mobile 3-D Secure extends payment authentication into mobile commerce, taking into account existing wireless security initiatives such as Mobey, Raddichio and WAP. Mobile 3-D Secure is meant to enable Visa card issuers to validate the identity of their cardholders in real time. It ensures that payment data sent over open networks is not compromised, and allows consumers to actively protect their Visa accounts from unauthorized use when shopping online over mobile devices. According to Visa, the specification also supports global interoperability in an attempt to enable consumers to have a consistent and seamless experience regardless of the method or device being used to access the Internet.

Yet another product Arcot TransFort of Arcot Systems USA has been selected by Visa as a Payer Authentication solution for their Secure Commerce Program. Arcot TransFort is a real-time payment authentication solution that will allow Visa member banks and Visa card processors to authenticate the identity of Visa cardholders during an online transaction, thereby greatly reducing the incidence of disputed payments.

When a customer enters their Visa card number in a Web checkout form and hits the buy button, a TransFort Merchant software module at the merchant site alerts a TransFort module at the card-issuing bank that someone is making a purchase using a Visa card. The TransFort module at the bank then requests that the customer authenticates himself or herself by entering a pass-code (or other means of authentication) in an authentication screen that appears on the customer's PC (or PDA or mobile phone). Once authenticated, the bank notifies the TransFort merchant module that the cardholder has been authenticated. A receipt of this notification is archived for purposes of non-repudiation. This greatly reduces the merchant's exposure to fraud and dispute. The Visa Authenticated Payment Program offers increased confidence to the customer and merchant with virtually no change in the online purchasing process.

Various other products exist in the market like Card Alerts (Ducont Inc), Equifax PayNet Secure (Equifax Inc), Seconfirm (Secos Inc). These products in the market provide security to credit card users in various forms, like SMS messages, wireless application protocol (WAP), or automated voice messages.

However these products have one or more drawbacks as given below. The systems have limited interactivity and these systems and products are very complicated, expensive and difficult to implement. The systems are not user friendly, as they require dedicated software and hardware to implement the functions.

In view of the above-mentioned shortcomings existing in products as well as the prior art, there exist a need for giving users/customers of the bank personalized control and management over the financial/banking transactions made by him.

### SUMMARY

An object of the present invention is to provide a security system to cardholders against misuse of their credit card.

Another object of the present invention is to provide credit card holders with a personalized control and management over the banking transaction made by them.

Another object of the present invention is to provide for a system and method that enable cardholders to be notified of the transaction made over by them using their credit card.

Yet another object of the present invention is to enable cardholder to be able to authorize transactions on their credit cards by defining personal rules for management of transactions.

A further object of the present invention is to provide a credit card holder with customized rules for appropriate action—notifications, authorizations, and refusals—that could act independent of the bank's system rules.

The present invention relates to a system and method of doing transactions using a card and getting confirmation of the transactions through a messaging service. The card user enters his card data at the point of sales terminal. The point of sale terminal sends a request to the acquiring bank system. The card fraud control system CFCS receives a request for validation from the issuing bank. The card fraud control system passes the request through the user defined personalized rules and assuming a successful match sees whether the user has opted for authorization or notification.

If the user has opted for notification, then assuming a successful match for notification rule, the CFC system sends a notification. This notification can be via a short messaging service SMS or multimedia messaging service or voice command to the user on his hand held device or any other preferred device giving details of the transaction. If the user has opted for authorization, a call is made to the user giving details like merchant name, location, amount, channel, time, etc. The user is further asked whether to authorize the transaction or not. The user has to key in a Personal Identification Number (PIN) given to him during the registration process. The CFC system validates the PIN and based on the result of the authentication the transaction is declined or accepted. In this way by using the CFC system, the user can make transactions using card in a secure and safe environment and is informed of every transaction.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram that illustrates an overview of the system in accordance with a preferred embodiment of the present invention.

FIG. 2 is a block diagram of software modules of the system in accordance with a preferred embodiment of the present invention.

FIG. 3 is a flow chart that illustrates the method and working of the rule engine in accordance with a preferred embodiment of the present invention.

FIG. 4 is a flow chart that illustrates the method of access and response of notification handler in accordance with a preferred embodiment of the present invention.

FIG. 5 is a flow diagram that illustrates the authorization scheme of transaction using the system in accordance with a preferred embodiment of the present invention.

FIG. 6 is a flow diagram that illustrates the notification scheme of transaction using the system in accordance with a preferred embodiment of the present invention.

### DESCRIPTION OF PREFERRED EMBODIMENTS

The present invention is directed to a system and method for detecting frauds in banking transactions that empowers the consumer to control their banking transactions. The present invention enables a consumer to be notified that a banking transaction is taking place and seek authorization for completing the same. The invention can also enable the consumer to decline or refuse a transaction.

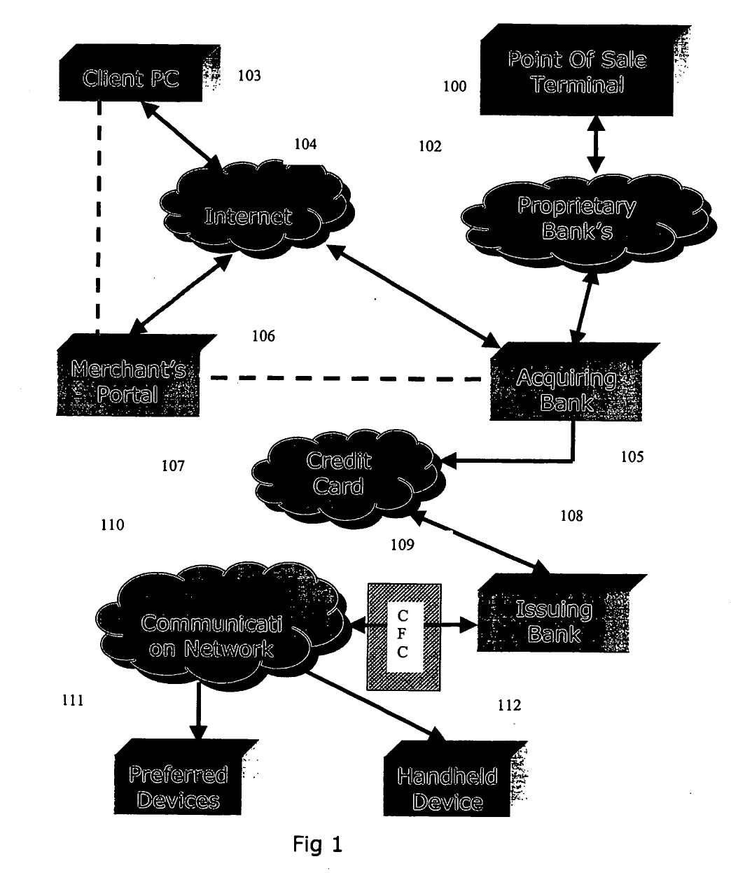

FIG. 1 is a block diagram that illustrates an overview of the system in accordance with a preferred embodiment of the present invention. The system comprises Point of Sale (POS) terminal 100 that is connected to a Proprietary Bank's Network 102. The POS 100 terminal can be a card reader at a retail outlet. It can even be a simple telephone operated manually that can be connected to Bank's network. A client PC 103 is connected to Merchants portal 106 via Internet 104. The card can be a credit card, smart card or any other electronic card for making payment. Information from POS terminal 100 and the merchant portal 106 is passed onto the acquiring bank system 105. The data forwarded usually consists of username, card number, amount of transaction etc.

The acquiring bank system 105 located with the acquiring bank passes the information about the transaction to the Issuing bank 108 via a credit card network 107. The issuing bank system 108 does its own security checks the authenticity of the user and in parallel forwards the request to the Card Fraud Control system 109 (CFC system). The CFC system 109 is called Self-guard, which is the main component of the invention. The user has to register with the CFC system 109 to benefit from its services. CFC system 109 has all the data required for the validation of the transaction along with the personalized rules, which are set by the user himself during the time of registration with the system. The various parameters on which the rules can be set are transaction amount, location of the transaction, time of the transaction, etc. The consumer can change these parameters by his hand held device using voice commands or through SMS. CFC 109 is connected to a communication network 110. Communication network 110 connects to various wired and wireless devices. The communication network 110 can connect to preferred devices 111. Preferred devices 111 can be specific hardware devices on which messages can be received. Communication network 110 can also communicate to various handheld devices 112. The hand held device 112 can be a mobile phone, palm top or a telephone. There are two types of transaction that can take place depending upon the choice of the user—authorization or notification. This has to be given at the time of registering.

In the case the choice is for authorization, CFC system 109 on receiving the data from issuing bank system 108 passes the request through user defined personalized rules. It then makes a call to the user on his hand held device 112 or preferred device 111 and queries the user whether he wants to proceed with the transaction. The user has to key in a Personal Identification Number PIN given to him during the registration process. The CFC System 109 validates the PIN and based on the result of the authentication, the transaction is declined or completed successfully.

In the case the choice is for notification, the CFC system 109 on receiving the data from the issuing bank system 108 passes the request through user defined personalized rules. It then sends a SMS/MMS message to the user informing him about the transaction and the details thereof. SMS is a service for sending messages of up to 160 characters to mobile phones that use Global System for Mobile (GSM) communication. MMS is a multimedia messaging service, which is used to send text and graphics to mobile phones. Therefore, the user is informed that his card is being used for a transaction.

A similar transaction can take place on the Clients PC 103 where the user goes for online shopping. After the user selects the item he wants to purchase he enters the card number on the PC terminal 103. The card number after being transmitted to the acquiring bank system 105 through the merchant portal 106 is received by the credit card network 107. Credit card network 107 passes the details to issuing bank system 108 that does its own sanity checks. Thereafter, CFC system 109 then checks whether authorization/notification is requested. If notification is requested the CFC system 109 inform the user on his hand held device 112 or a preferred device 111 through the communication network 110. If authorization is requested, then the user is requested for a PIN on the hand held device 112 or preferred device 111. On entering the PIN the transaction is verified and completed.

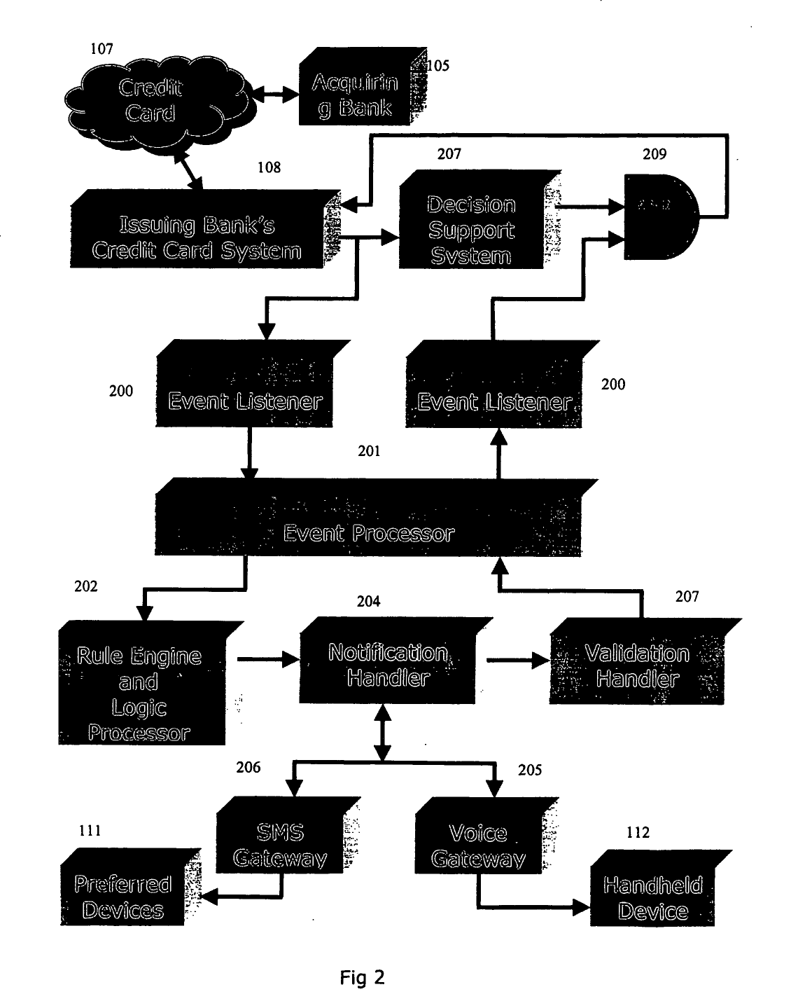

FIG. 2 is a block diagram of CFC system 109 that describes all the software modules, in accordance with a preferred embodiment of the present inventions. When the user goes for any credit card transaction, the details of the transaction are forwarded to the acquiring bank system 105. Acquiring bank system 105 forwards the same to the issuing bank system 108 through the credit card network 107. Issuing bank system 108 then forwards the request to the CFC system 109. The CFC system 109 comprises of an event listener 200, event processor 201, rule engine 202, logic processor 203, notification handier 204, voice gateway 205, SMS gateway 206 and a validation handler 207.

The software module Event Listener 200, is a component that constantly monitors the state of the system, and when it detects a transaction or receives any message or request from issuing bank system 101, extracts the relevant information and activates event processor 201 and passes down the information to it.

Event processor 201 takes the details of the transaction as the input, normalizes, XMLises and then passes down this information to rule engine 202. Normalize means to collapse two or more adjacent text nodes in the document tree into one text node. This ensures that the tree structure will match tree structure generated when the document is stored and reloaded. XML is a flexible way to create common information formats and share both the format and the data on the World Wide Web, intranets, and elsewhere.

The module 202 is rule engine. This processes the request from event processor 201. It picks up the rules of transaction set by the user at the time of registration from the database and matches them with the request. These rules are defined by the user using a Rules Wizard that creates conditions with credit card transaction parameters such as amount of transaction, time of transaction, location of merchant, merchant type and channel used for transaction. The rules are in the form of operands and the logical operators such as and, not, greater than, less than, etc. as operators. For example, a rule could be if the transaction amount is greater than 1000 Dollars AND the city of merchant is other than where I live, then ask for authorization. The user can create multiple rules and have control over the values, operators and the operands (parameters) used in creating a rule. Some of the parameters such as the amount of transaction, time of transaction, merchant code, card number, expiry date, etc. are available to the Credit Card Issuer from the network requesting authorization (VisaNet, Inet, etc.) while others are available from its own systems.

If the request matches a rule or a set of rules, it is passed on to logic processor module 203. Logic Processor module 203 gets the request from the rule engine 202 and accordingly the order of precedence is set. The order of precedence is decline, authorize and notify.

Logic processor 203 passes down the order of precedence to notification handler 204, which takes the decision on the basis of the result of logic processor 203. Notification handler 204 informs the appropriate gateway about the notification requests.

In case of the request by the user is for the notification, the notification handler sends a request to the SMS gateway module 206. SMS gateway module sends a SMS to the preferred device 111 informing him about the details of the transaction.

In case the request by the user is for the authorization, notification handler informs the voice gateway 205. This voice gateway module 205 is responsible for making the call to the user on his hand held device 112. The module picks up the user's phone from the profile stored in the Lightweight Directory Access Protocol LDAP and dials out to the user. LDAP is a software protocol for enabling anyone to locate organizations, individuals, and other resources such as files and devices in a network, whether on the public Internet or on a corporate Intranet. The user has to key in a Personal Identification Number PIN given to him during the registration process. The validation handler module 207 accepts the PIN from the user, validates the PIN and forwards the results of the validation to event processor 201. The event listener 200 sends the information to a decision support system 207. The issuing bank 108 exposes each credit card transaction to CFC system 109, in parallel with its own decision support system 207 or other fraud control and authorization systems.

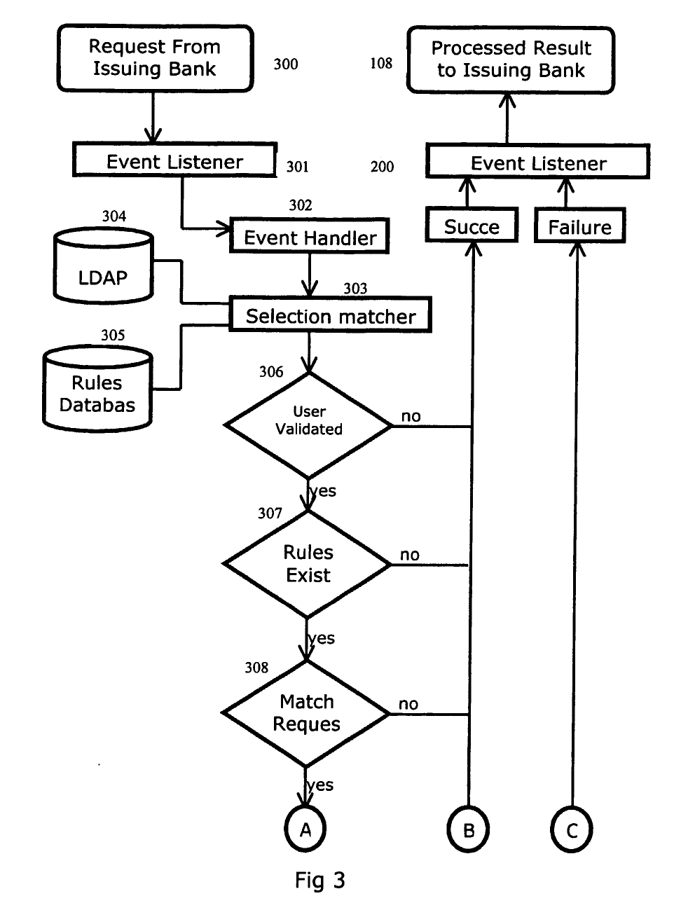

FIG. 3 is a flow chart that illustrates the method and working of rule engine 202 in accordance with the preferred embodiment of the present invention. At step 300 the issuing bank sends a request. At step 301 the request is received by event listener 202. At step 302 the events are passed to the event handler. At step 303 the requested data is matched by the selection matcher with the data retrieved from the rules database 305 or LDAP database 304. At step 306 the user is validated. If user is not validated the request is sent to issuing Bank System 108 through the event listener 200. At step 307 if the rules exist then they are matched. If rules do not exist then the no rules request is forwarded to the issuing bank system 108 through the event listener 200. At step 308 the request is matched against all rules and forwarded to notification handler 204. If the request is not matched with any rules then K implies that no action is to be taken against any particular transaction hence no rules match request is sent to the issuing bank system 108 through the event listener 200.

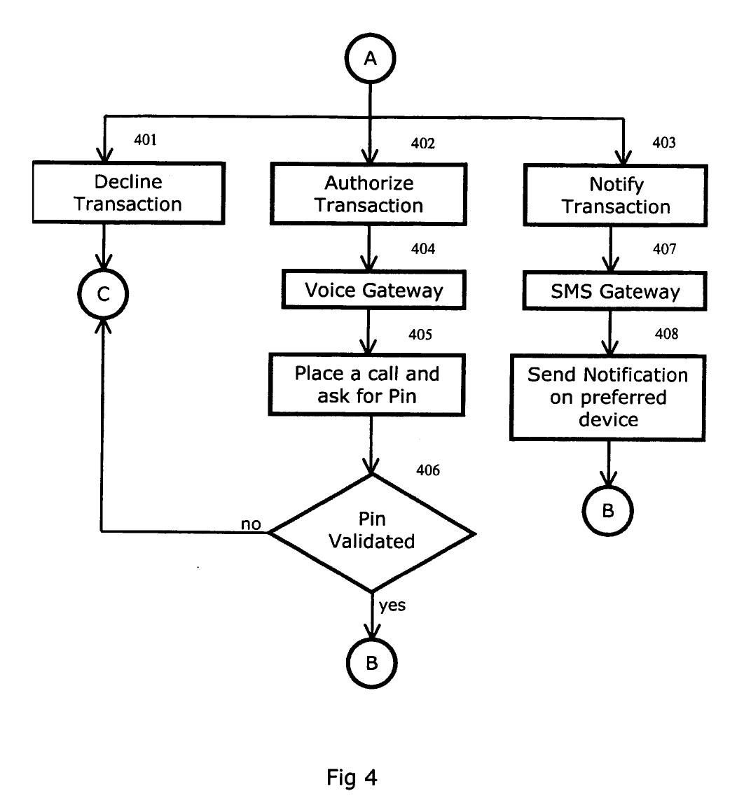

FIG. 4 is a flow chart that illustrates the method of access and response of notification handler 204 in accordance with a preferred embodiment of the present invention. At step 401 rules are matched and transaction declined. When the transaction is declined a failure request is sent to the issuing bank system 108 through the event listener 200. At step 402 the transaction is authorized. Upon authorization, at step 404 the request is sent to the voice gateway 205. At step 405 a call is placed to the hand held device 112 which request for PIN. At step 406 the PIN is validated. If PIN is correct then a successful request is sent to the issuing bank system 108 through the event listener 200. If the PIN is not validated then a failure request is sent to the issuing bank system 108 through the event listener 200. At step 403 notify transaction request is sent through the step 407 of the SMS gateway 206. At step 408 the notification is sent to a preferred device 111 and a successful request is sent to the issuing bank system 108 through the event listener 200.

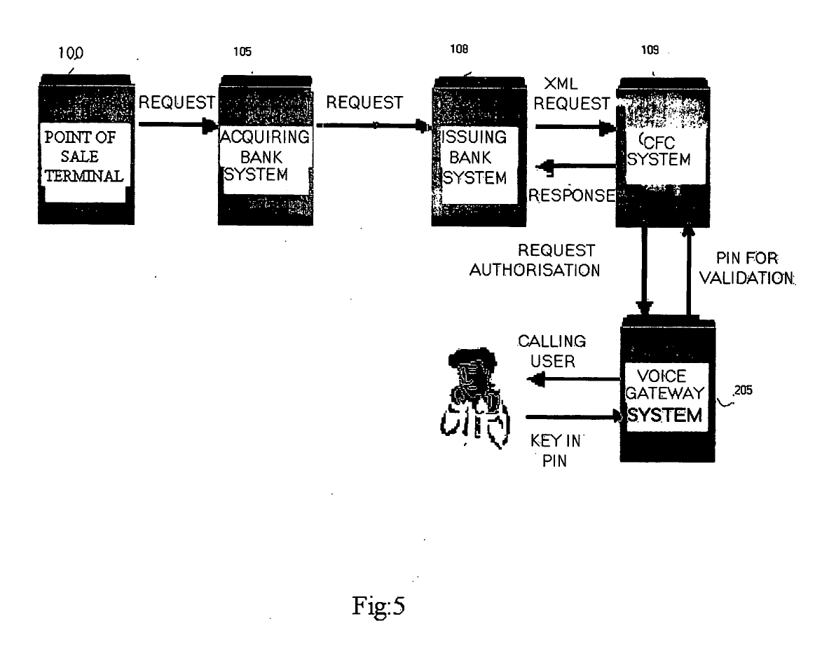

FIG. 5 is a flow diagram of authorization scheme in accordance with preferred embodiment of the present invention. When a user does a transaction on his card at a point of sale 100, the POS passes down the card information containing username, card number, transaction etc. to acquiring bank system 105. Acquiring bank system 105 forwards all the details to issuing bank system 108, which has issued the card. Issuing bank system 108 on receiving the information performs its own checks and also passes the information to the CFC system 109. CFC system 109 checks the database for all the information forwarded to it by issuing bank system 108. CFC system 109 also retrieves the rules, which the card user has set at the time of registering. Thereafter, CFC system 109 compares the rules retrieved from the database with the rules it has received from issuing bank system 108 along with the card information. If, the rules are found valid, the information is further passed down to voice gateway 205 of the CFC system 109, otherwise a message-conveying non-authentication is sent to issuing bank system 108. Voice gateway 205 then makes a call to the user on his hand held device 112 requesting him to enter his PIN. On receiving the PIN number from the user and verifying it, CFC system 109 gives a message to issuing bank system 108 to complete the transaction.

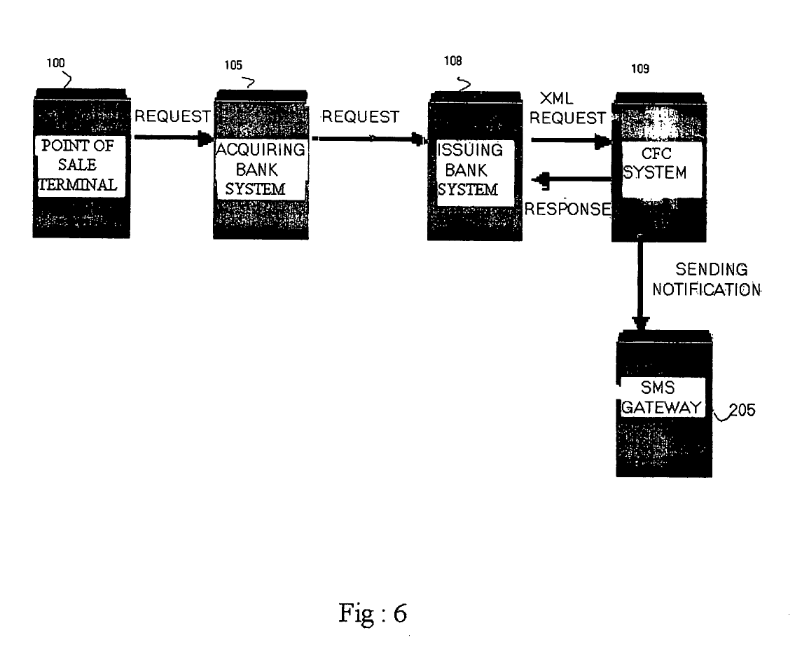

FIG. 6 is a flow diagram for the notification scheme in accordance with preferred embodiment of the present invention. A user does a transaction on his card at a point of sale POS terminal 100, which then passes the card information containing username, card number, transaction etc. to acquiring bank system 105. Acquiring bank system 105 forwards all the details to issuing bank system 108, which has issued the card. Issuing bank system 108 on receiving the information performs its own checks and passes the information to CFC system 109. The CFC system 109 checks the database for all the information forwarded to it by issuing bank system 108. The CFC system 109 also retrieves the rules, which the card user has set at the time of registering. Thereafter, CFC System 109 compares the rules retrieved from the database with the rules it has received from issuing bank system 108 along with the card information. If, the rules are found valid the information is further passed down to SMS gateway 206 of CFC system 109, otherwise a message-conveying non-authentication is sent to issuing bank system 108. SMS gateway 206 then sends a message to a preferred device 111 of the user informing him about the transaction and then CFC system 109 also gives a message to issuing bank system 108 to complete the transaction.

The authorization and notification are best explained by way of examples given below.

Mike walks into a shop selling books. He purchases a book on Financial Management worth US $200. He wants to pay by credit card, as he is not carrying sufficient cash with him. He gives his credit card to the seller, who swipes his card at point of scale terminal 100. POS terminal 100 passes down the information to the acquiring bank system 105 where it is connected. Acquiring bank system 105 then passes down the information to issuing bank system 108. Issuing bank system 108 does it own checking and at the same time passes the complete details to CFC system 109. CFC system 109 checks for all the rules and data it has for Mike with the information it got from issuing bank system 108. On finding the information is valid, it makes call on Mike's hand held device 112 asking him to enter his PIN number, Mike enters his PIN number and on receiving the same, the CFC system 109 informs the issuing bank system 108 to complete the transaction.

Sarah is surfing a site selling flowers on the Internet. She wants to purchase a bunch of Tulips from the site. She orders for the Tulips and clicks on the option of pay by credit card. On submitting the button a screen asks for her credit card number and other details, which she promptly enters and then presses submit. The card-reader software on the Internet site reads the information and passes it down to acquiring bank system 105 where it is connected. The acquiring bank 105 then passes down the information to issuing bank system 108. The issuing bank system 108 does its own checking and at the same time passes the complete details to the CFC system 109. The CFC system 109 checks for all the rules and data it has for Sarah with the information it got from the issuing bank system 108. On finding the information valid, it sends a SMS message on Sarah's preferred device 111 informing her about the transaction.

In this way the CFC system 109 enables the card user to do transaction in a safe manner and also eliminate the chance of its misuse in case it is lost or stolen.

The present invention has been described for the credit transactions. However, as one skilled in the art would appreciate, the present invention can also be used for all kinds of banking and financial transactions/instruments such as credit cards, cheques, demand drafts, wired transfers, etc. It is also independent of the channel that is being used for the transaction—POS, telephone or the web.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A banking transaction fraud control system, said banking transaction fraud control system used for informing a user about the financial transaction, said financial transaction is through a point of sale terminal, said system comprising
an event listener module for detecting the occurrence of the event;
an event processor module for normalizing the event;
a rule engine module for processing the event as per defined rules;
a logic processor module for analyzing the output;
a notification handler module for selecting the relevant gateway;
a messaging gateway for sending messages on said user hand held device; and
a validation handler module for authenticating said card transaction.

2. The system as recited in claim 1 wherein the event listeners are components.

3. The system as recited in claim 2 wherein the components constantly monitor the state of said card fraud control system.

4. The system as recited in claim 1 wherein on detection of an event the relevant information is extracted.

5. The system as recited in claim 2 wherein said components activate the said event processor.

6. The system as recited in claim 1 wherein said event processor converts the input into an extensible markup language format.

7. The system as recited in claim 1 wherein the said user can create said rules.

8. The system as recited in claim 1 wherein said rules can be changed by said user using messaging service.

9. The system as recited in claim 1 wherein said rules can be changed by said user through a computer terminal.

10. The system as recited in claim 1 wherein said rules can be changed using voice commands.

11. The system as recited in claim 1 wherein said rules are stored in a relational database.

12. The system as recited in claim 1 wherein said logic processor sets the order of precedence.

13. The system as recited in claim 12 wherein said order of precedence is decline, authorize and notify.

14. The system as recited in claim 1 wherein said messaging gateway is a short message service gateway.

15. The system as recited in claim 1 wherein said messaging gateway is a voice gateway.

16. The system as recited in claim 1 wherein said validation handler module captures the personal identification number of said user.

17. The system as recited in claim 1, wherein the system is embodied as a computer program.

18. A banking transaction fraud control method, said banking transaction fraud control method used for informing a user about the financial transaction, said financial transaction is through point of sale terminal, said method comprising steps of:
requesting a financial transaction;
receiving of the request by the acquiring bank;
forwarding the request to the issuing bank;
forwarding the request from said issuing bank to banking transaction fraud control system and;
authorizing said financial transaction.

19. A method as recited in claim 18 wherein requesting a banking transaction is through a card swipe terminal.

20. A method as recited in claim 18 wherein requesting a banking transaction is through a computer terminal.

21. A method as recited in claim 18 wherein the authorizing said banking transaction is done through messaging service.

22. A method as recited in claim 18 wherein the authorizing said banking transaction is done by entering a personal identification number.

23. A method as recited in claim 18 wherein the authorizing said banking transaction is done by using voice commands.

24. A banking transaction fraud control method, said banking transaction fraud control method used for informing a user about the financial transaction, said financial transaction is through a point of sale terminal, said method comprising steps of:
requesting a financial transaction;
receiving of the request by the acquiring bank;
forwarding the request to the issuing bank;
forwarding the request from said issuing bank to banking transaction fraud control system; and
notifying said financial transaction.

25. A method as recited in claim 24 wherein the requesting a financial transaction is through a card swipe terminal.

26. A method as recited in claim 24 wherein the requesting a financial transaction is through a computer terminal.

27. A method as recited in claim 24 wherein the notifying said financial transaction is done through a messaging service.

28. A method as recited in claim 24 wherein said messaging service is a short message service.

29. A method as recited in claim 24 wherein said messaging service is a multimedia service.

30. A method as recited in claim 24 wherein said messaging service is a voice command.
